(19) United States
(12) Patent Application Publication
(10) Pub. No.: US 2022/0027208 A1
(43) Pub. Date: Jan. 27, 2022

(54) METHOD FOR CONTROLLING OF ACCELERATING EDGE PLATFORM NETWORK AND ELECTRONIC DEVICE USING THE SAME

(71) Applicant: NetLOX Co.,Ltd., Seongnam-si (KR)

(72) Inventors: Seok Hwan Kong, Yongin-si (KR); Dipjyoti Saikia, Seongnam-si (KR)

(73) Assignee: NetLOX Co.,Ltd, Seongnam-si (KR)

(21) Appl. No.: 17/383,331

(22) Filed: Jul. 22, 2021

(30) Foreign Application Priority Data
Jul. 24, 2020 (KR) 10-2020-0092231
Jul. 24, 2020 (KR) 10-2020-0092244
Feb. 10, 2021 (KR) 10-2020-0169985

(51) Int. Cl. G06F 9/50; H04L 12/935; G06F 9/455; G06F 8/41

(52) U.S. Cl. CPC G06F 9/5077; H04L 49/30; G06F 2209/509; G06F 8/41; G06F 9/455

(57) ABSTRACT

A method of an electronic device according to various embodiments may include: an operation of serving, by an edge node CPU including at least one core, a control plane for a network function including a virtualization function; and an operation of serving, by a smart network interface card (NIC), a data plane for the network function including the virtualization function to offload at least some operations for the network function including the virtualization function in at least one core. Other embodiments are also available.

### TECHNICAL FIELD

Various embodiments of the present invention relate to a network control method and an electronic device using the same, and particularly, to an edge platform network accelerating solution.

### BACKGROUND ART

In today's fourth industries as a topic, a vast amount of data can be hyper-connected through various devices. In such an environment, innovative convergence new product and service solution markets may be expanded, which reflect user's needs, and securing an infrastructure capable of development, testing, and demonstrating products for this may be required.

Things of Internet (IoT) traffic is continuously increasing, and such a trend may be continued in the future. The growth of such a trend may be caused by an increase in the number of devices on the things of Internet (IoT). For example, various types of IoT devices including existing phones, PCs, smartphones, set-top boxes, household appliances, wearable devices, connected cars, augmented/virtual reality devices (AR/VR) are emerging.

### DISCLOSURE

### Technical Problem

5G as an enabler which enables various services in enhanced mobile broadband (eMBB), massive machine-type communication (mMTC), ultra-reliable and low latency communications (uRLLC) technical environments may cause integrating overall industries and various dedicated networks related to explosive increase of data into one network. However, problems with existing legacy systems required for constructing 5G based edge computing may be emerged. For example, in terms of performance, ultra low latency/ultra high speed traffic transmission may be impossible during existing CPU based networking. For example, in terms of cost, due to a CPU load due to networking, service integrity may deteriorate, and as a result, multiple CPU servers may be required. For example, in terms of flexibility, fixed networking in which new functions and services may not be provided on demand may become a problem. In terms of security, during CPU-based processing, 5G may be subjected to performance deterioration due to multiple security policies and may be vulnerable to random attacks by unspecified many persons, such as a DDoS attack.

### Technical Solution

A method of an electronic device according to various embodiments may include: an operation of serving, by an edge node CPU including at least one core, a control plane for a network function including a virtualization function; and an operation of serving, by a smart network interface card (NIC), a data plane for the network function including the virtualization function to offload at least some operations for the network function including the virtualization function in at least one core.

The network function including the virtualization function may further include a physical network function performed by directly allocating a hardware resource.

The edge node CPU may be configured to perform a function offloaded based on a x86 architecture.

At least one core may include 24 cores.

The operation of serving the control plane may include an operation of activating 4 cores among 24 cores.

The operation of offloading at least some operations for the network function including the virtualization function may include an operation of deactivating 12 cores among at least one core.

The smart NIC may be a software-based NIC.

The smart NIC may be an NIC implemented by a software defined network (SDN).

The smart NIC may be configured to operate with a compiler.

The operation of serving the control plane for the network function including the virtualization function may include an operation of using the compiler in a software stack.

The operation of serving the control plane for the network function including the virtualization function and the operation of serving the data plane for the network function including the virtualization function may be configured not to be executed together by the edge node CPU.

An electronic device according to various embodiments may include: a software stack serving, by an edge node CPU including at least one core, a control plane for a network function including a virtualization function; a smart NIC including a switch data plane serving a data plane for the network function including the virtualization function; and an edge node CPU offloading at least some operations for the network function including the virtualization function in the at least one core.

The electronic device may further include a compiler in which the virtualization function offloaded from the switch data plane to the edge node CPU generates a binary code performed by the switch data plane.

The electronic device may further include a data plane management module performing an operation of transmitting the binary code to the switch data plane and requesting executing the binary code.

The electronic device may further include the general NIC, and the data plane management module may request the general NIC to perform a network function which is not virtualized.

The electronic device may further include a high-speed data path framework performing an operation of offloading the virtualization function from the switch data plane to the edge node CPU.

The electronic device may further include a high-speed data path framework performing an operation of offloading the virtualization function from the switch data plane to the edge node CPU.

### DESCRIPTION OF DRAWINGS

FIG. 1 is a block diagram of an electronic device in a network environment according to various embodiments of the present invention.

FIG. 2A is a diagram schematically illustrating an architecture of a software stack according to various embodiments of the present invention.

FIG. 2B is a diagram schematically illustrating an architecture of a software stack according to various embodiments of the present invention.

FIG. 2C is a diagram schematically illustrating a port mapping relation between an architecture of a software stack and smart NIC according to various embodiments of the present invention.

FIGS. 3A and 3B are diagrams illustrating a difference between a smart NIC based networking solution and the other networking solution according to various embodiments of the present invention.

FIG. 4A is a diagram schematically illustrating a packet flow of a smart NIC based networking solution according to various embodiments of the present invention.

FIG. 4B is a diagram illustrating a difference in packet flow between a smart NIC based networking solution and the other networking solution according to various embodiments of the present invention.

FIGS. 5A and 5B are diagrams illustrating a difference between a smart NIC based networking solution and the other networking solution according to various embodiments of the present invention.

FIG. 6 is a flowchart for an algorithm of a smart NIC based networking solution according to various embodiments of the present invention.

### MODE FOR INVENTION

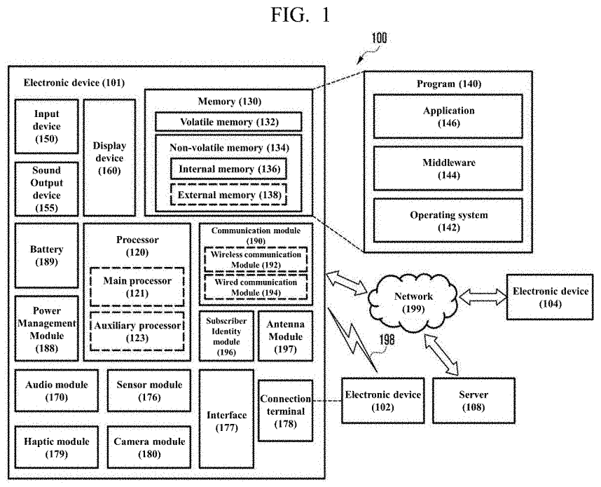

FIG. 1 is a block diagram of an electronic device 101 in a network environment 100 according to various embodiments of the present invention. Referring to FIG. 1, in the network environment 100, the electronic device 101 may communicate with an electronic device 102 through a first network 198 (e.g., a short-range wireless communication network) or communicate with an electronic device 104 or a server 108 through a second network 199 (e.g., a long-range wireless communication network). According to an embodiment, the electronic device 101 may communicate with the electronic device 104 through the server 108. According to an embodiment, the electronic device 101 may include a processor 120, a memory 130, an input device 150, an sound output device 155, a display device 160, an audio module 170, a sensor module 176, an interface 177, a haptic module 179, a camera module 180, a power management module 188, a battery 189, a communication module 190, a subscriber identification module 196, or an antenna module 197. In some embodiments, at least one (e.g., display device 160 or camera module 180) of the components may be omitted from or one or more other components may be added to the electronic device 101. In some embodiments, some of the components may be implemented as one integrated circuit. For example, the sensor module 176 (e.g., a fingerprint sensor, an iris sensor, or an illuminance sensor) may be implemented while being embedded in the display device 160 (e.g., a display).

For example, the processor 120 executes software (e.g. the program 140) to control at least one other component (e.g., a hardware or software component) of the electronic device 101 connected to the processor 120 and perform various data processing or operations. According to an embodiment, as at least some of the data processing or operations, the processor 120 may load, to a volatile memory 132, instructions or data received from other components (e.g., the sensor module 176 or the communication module 190), process the instructions or data stored in the volatile memory 132, and store result data in a non-volatile memory 134. According to an embodiment, the processor 120 may include a main processor 121 (e.g., a central processing unit or an application processor) and an auxiliary processor 123 (e.g., a graphic processing unit, an image signal processor, a sensor sub processor, or a communication processor) which is operable independently from or together with the main processor 121. Additionally or alternatively, the auxiliary processor 123 may be configured to use lower power than the main processor 121 or to be specialized to a specified function. The auxiliary processor 123 may be implemented separately from the main processor 121 or as a part of the main processor 121.

The auxiliary processor 123 may control at least some of functions or states related to at least one component (e.g., the display device 160, the sensor module 176, or the communication module 190) of the components of the electronic device 101 instead of the main processor 121 while the main processor 121 is in an inactive (e.g., sleep) state or together with the main processor 121 while the main processor 121 is in an active (e.g., application execution) state. According to an embodiment, the auxiliary processor 123 (e.g., an image signal processor or a communication processor) may be implemented as a part of another component (e.g., the camera module 180 or the communication module 190) which is functionally related.

The memory 130 may store various data used by at least one component (e.g., the processor 120 or the sensor module 176) of the electronic device 101. The data may include, for example, software (e.g., the program 140) and input data or output data for an instruction related to the software. The memory 130 may include the volatile memory 132 or the non-volatile memory 134.

The program 140 may be stored in the memory 130 as the software, and may include, for example, an operating system 142, middleware 144, or an application 146.

The input device 150 may receive the instruction or data to be used for the component (e.g., the processor 120) of the electronic device 101 from the outside (e.g., a user) of the electronic device 101. The input device 150 may include, for example, a microphone, a mouse, or a keyboard.

The sound output device 155 may output an sound signal to the outside of the electronic device 101. The sound output device 155 may include, for example, a speaker or a receiver. The speaker may be used for a general purpose such as multimedia reproduction or recording reproduction, and the receiver may be used for receiving an incoming call. According to an embodiment, the receiver may be implemented separately from the speaker or as a part of the speaker.

The display device 160 may visually provide information to the outside (e.g., the user) of the electronic device 101. The display device 160 may include, for example, a display, a hologram device, or a projector and a control circuit for controlling the corresponding device. According to an embodiment, the display device 160 may include a touch circuitry configured to sense a touch or a sensor circuitry (e.g., a pressure sensor) configured to measure an intensity of force generated by the touch.

The audio module 170 may convert sound into an electric signal and reversely, convert the electric signal into the sound. According to an embodiment, the audio module 170 may acquire the sound through the input device 150 or output the sound through an external electronic device (e.g., the electronic device 102) (e.g., the speaker or a headphone) directly or wirelessly connected to the sound output device 155 or the electronic device 101.

The sensor module 176 may sense an operation state (e.g., power or temperature) of the electronic device 101 or an external environmental state (e.g., a user state) and generate an electric signal or a data value corresponding to the sensed state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor.

The interface 177 may support one or more designated protocols which may be used for the electronic device 101 to be directly or wirelessly connected to the external electronic device (e.g., the electronic device 102). According to an embodiment, the interface 177 may include, for example, a high-definition multimedia interface (HDMI), a universal serial bus (USB) interface, an SD card interface, or an audio interface.

A connection terminal 178 may include a connector for the electronic device 101 to be physically connected to the external electronic device (e.g. the electronic device 102) through the interface 177. According to an embodiment, the connection terminal 178 may include, for example, an HDMI connector, a USB connector, an SD card connector, or an audio connector (e.g., a headphone connector).

The haptic module 179 may convert the electric signal into a mechanical stimulus (e.g., vibration or motion) or an electrical stimulus which the user may recognize through a tactile or exercise sensation. According to an embodiment, the haptic module 179 may include, for example, a motor, a piezoelectric element, or an electrical stimulus device.

The camera module 180 may photograph a still image and a moving picture. According to an embodiment, the camera module 180 may include one or more lenses, image sensors, image signal processors, or flashes.

The power management module 188 may manage power supplied to the electronic device 101. According to an embodiment, the power management module 188 may be implemented as at least a part of a power management integrated circuit (PMIC), for example.

The battery 189 may provide power to at least one component of the electronic device 101. According to an embodiment, the battery 189 may include, for example, a recharge impossible primary battery, a rechargeable secondary battery, or a fuel cell.

The communication module 190 may support establishment of a direct (e.g., wired) communication channel or a wireless communication channel between the electronic device 101 and the external electronic device (e.g., the electronic device 102, the electronic device 104, or the server 108) and communication execution through the established communication channel. The communication module 190 may include one or more communication processors which are operated independently from the processor 120 (e.g., the application processor) and support one or more communication processors supporting the direct (e.g., wired) communication or the wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication module). A corresponding communication module of the communication modules may communicate with the external electronic device through a first network 198 (e.g., a short-range communication network such as Bluetooth, Wi-Fi direct or infrared data association (IrDA)) or a second network 199 (e.g., a short-range communication network such as a cellular network, the Internet, or a computer network (e.g., LAN or WLAN)). The types of communication modules may be integrated into one component (e.g., single chip), or may be implemented as a plurality of separate components (e.g., plural chips). The wireless communication module 192 may check and authenticate the electronic device 101 in the communication network such as the first network 198 or the second network 199 by using subscriber information (e.g., international mobile subscriber identity (IMSI)) stored in the subscriber identification module 196.

The antenna module 197 may transmit the signal or power to the outside (e.g., the external electronic device) or receive the signal or power from the outside. According to an embodiment, the antenna module 197 may include one or more antennas, and therefrom, at least one antenna suitable for a communication scheme used in the communication network such as the first network 198 or the second network 199 may be selected by the communication module 190, for example. The signal or power may be transmitted or received between the communication module 190 and the external electronic device through the at least one selected antenna.

At least some of the components may be connected to each other through a communication scheme (e.g., a bus, a general-purpose input and output (GPIO), a serial peripheral interface (SPI), or a mobile industry processor interface (MIPI)) between peripheral devices and exchange the signal (e.g., instruction or data) with each other.

According to an embodiment of the present invention, the instruction or data may be transmitted or received between the electronic device 101 and the external electronic device 104 through the server 108 connected to the second network 199. The respective electronic devices 102 and 104 may be devices of the same type as or different types from the electronic device 101. According to an embodiment, all or some of the operations executed in the electronic device 101 may be executed in one or more external devices of the external electronic devices 102, 104, or 108. For example, when the electronic device 101 should perform any function or service automatically or in response to a request from the user or another device, the electronic device 101 may request one or more external electronic devices to perform at least a part of the function or service instead of or in addition to autonomously executing the function or service. One or more external electronic devices receiving the request may execute at least a part of the requested function or service or an additional function or service related to the request and transfer a result of the execution to the electronic device 101. The electronic device 101 may process the result as it is or additionally and provide the processed result as at least a part of a response to the request. To this end, for example, cloud computing, distributed computing, or client-server computing technology may be used.

The electronic devices according to various embodiments disclosed in this document may become various types of devices. The electronic device may include, for example, a portable communication device (e.g., a smartphone), a computer device, a portable multimedia device, a portable medical device, a camera, a wearable device, or an appliance device. The electronic device according to the embodiment of this document is not limited to the above-described devices.

Various embodiments of this document and terms used therein are not intended to limit technical features described in this document to specific embodiments, and it should be understood that various embodiments and the terms include various modifications, equivalents, or substitutes for the corresponding embodiment. In connection with the description of the drawings, similar reference numerals may be used for similar or related components. A singular type of a noun corresponding to an item may include one or a plurality of items unless a related context is apparently differently indicated. In this document, each of phrases such as “A or B”, “at least one of A and B”, “at least one of A or B”, “A, B, or C”, “at least one of A, B, and C”, and “at least one of A, B, or C” may include all possible combinations of items listed together with a corresponding phrase among the phrases. Terms such as “first” or “second” may be just used for distinguishing a corresponding component from the other corresponding component and the corresponding components are not limited in other aspects (e.g., importance or order). When it is mentioned that any (e.g., first) component is “coupled” or “connected” to the other (e.g., second) component together with a term “functionally” or “communicationally” or without the term, it means that the any component can be connected to the other component directly (e.g., wiredly), wirelessly, or through a third component.

The term “module” used in this document may include a unit implemented as hardware, software, or firmware, and may be used intercompatibly with a term such as logic, a logic block, a part, or a circuit, for example. The module may be an integrally configured part or a minimum unit or a part of the part, which performs one or more functions. For example, according to an embodiment, the module may be implemented in the form of an application-specific integrated circuit (ASIC).

Various embodiments of this document may be implemented as software (e.g., the program 140) including one or more instructions stored in a storage medium (e.g., an internal memory 136 or an external memory 138) readable by a machine (e.g., the electronic device 101). For example, the processor (e.g., the processor 120) of the device (e.g., the electronic device 101) may call at least one instruction of one or more instructions from the storage medium and execute the called instruction. This enables the device to be operated to perform at least one function according to the at least one called instruction. The one or more instructions may include a code generated by a compiler or a code executable by an interpreter. The storage medium readable by the device may be provided as a form of a non-transitory storage medium. Here, ‘non-transitory’ just means that the storage medium is a tangible device and does not include a signal (e.g., an electromagnetic wave), and this term does not distinguish a case where data is semi-persistently stored in the storage medium and a case where the data is temporarily stored.

According to an embodiment of the present invention a method according to various embodiments disclosed in this document may be provided while being included in a computer program product. The computer program products may be traded between a seller and a purchaser as merchandise. The computer program products may be distributed in the form of a device readable storage medium (e.g., compact disc read only memory (CD-ROM) or distributed (e.g., downloaded or uploaded) online directly through an application store (e.g., Play Store™) or between two user devices (e.g., smartphones). In the case of online distribution, some of the computer program products may be at least transitorily stored in a device readable storage medium such as a server of a manufacturer, a server of the application store, or a memory of a relay server, or temporarily generated.

According to various embodiments, each component (e.g., a module or program) of the above-described components may include a single or a plurality of entities. According to various embodiments, one or more components or operations of the above-described components may be omitted, or one or more other components or operations may be added. Alternatively or additionally, the plurality of components (e.g., the module or program) may be integrated into one component. In this case, the integrated component may perform one or more functions of respective components of the plurality of components in the same or similar manner as performing the function by the corresponding component of the plurality of components before the integration.

According to various embodiments, operations performed by modules, programs, or other components are executed sequentially in parallel, repeatedly, or heuristically, or one or more of the above operations may be executed in different orders or omitted, or one or more other operations may be added.

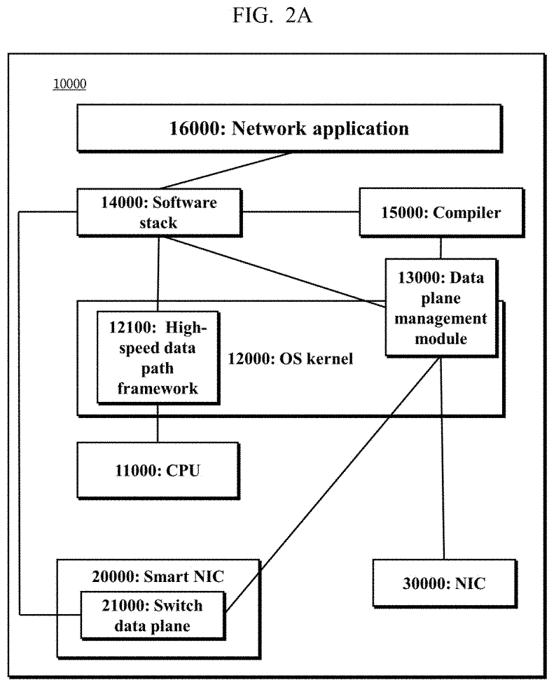

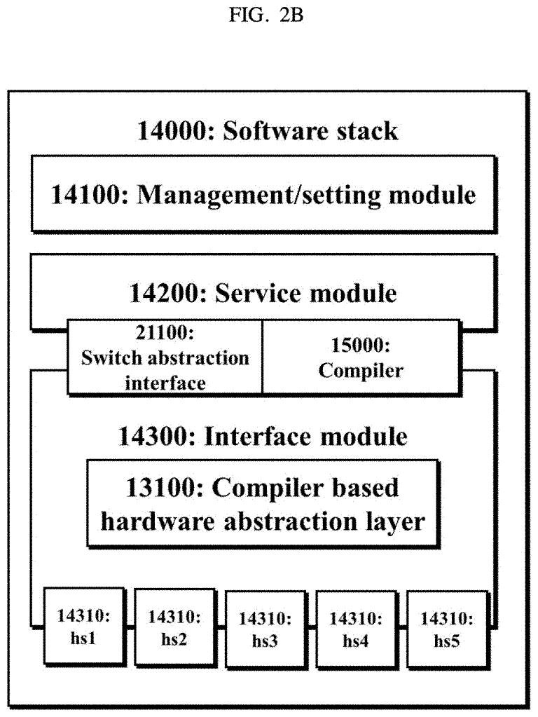

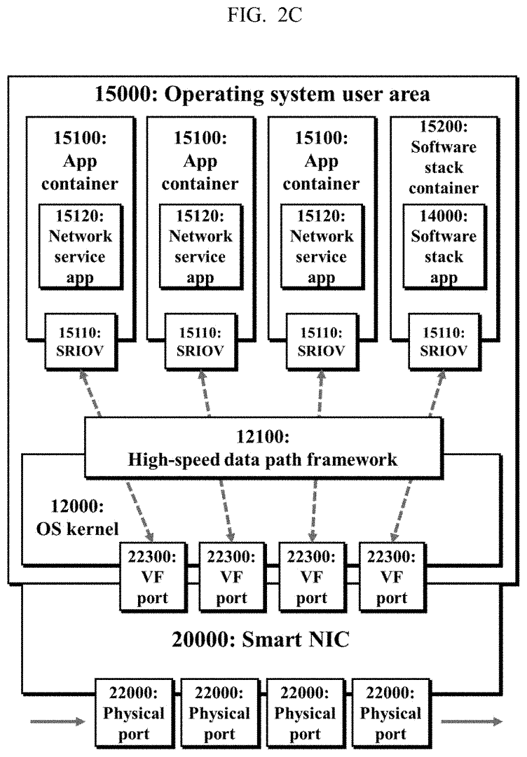

FIG. 2A is a diagram schematically illustrating an architecture of an electronic device according to various embodiments of the present invention.

An embodiment of the present invention may include:

a software stack 14000 serving a control plane for a network function including a virtualization function an edge node CPU including at least one core;

a smart NIC 20000 including a switch data plane 21000 serving a data plane for the network function including the virtualization function; and

an edge node CPU 11000 offloading at least some operations for the network function including the virtualization function in the at least one core.

An embodiment of the present invention may further include a compiler 15000 in which the virtualization function offloaded from the switch data plane 21000 to the edge node CPU 11000 generates a binary code performed by the switch data plane.

An embodiment of the present invention may further include a data plane management module 13000 performing an operation of transmitting the binary code to the switch data plane 21000 and requesting executing the binary code.

The electronic device may further include an operating system kernel 12000.

The data plane management module 13000 may be included in the operating system kernel 12000.

The data plane management module 13000 may include a library processing a data plane and/or a control driver controlling a smart NIC 20000 or a general NIC 30000. Further, the data plane management module 13000 may include an interface capable of controlling the smart NIC 20000 or general NIC 30000, e.g., an application programming interface (API) or an application. The data plane management module 13000 may be, for example, a data plane development kit (DPDK).

An embodiment of the present invention may further include the general NIC 30000, and the data plane management module 13000 may request the general NIC to perform a network function which is not virtualized.

An embodiment of the present invention may further include a high-speed data path framework 12100 performing an operation of offloading the virtualization function from the switch data plane 21000 to the edge node CPU 11000.

An embodiment of the present invention may further include a high-speed data path framework 12100 performing an operation of offloading the virtualization function from the switch data plane 21000 to the edge node CPU 11000.

The high-speed data path framework 12100 may add an initial hook to an RX path and the virtualization function may control processing of a packet. The hook may be disposed in an NIC driver included in the data plane management module just after interrupt processing and before allocating a memory required for a network stack itself.

The high-speed data path framework 12100 may be included in the operating system kernel 12000.

The smart NIC may further include a Field Programmable Gate Array (FPGA) 22400.

The smart NIC may further include an Application Specific Integrated Circuit (ASIC) 22200.

The smart NIC may further include a neural processing unit (NPU) 22300.

The smart NIC may further include a graphics processing unit.

According to various embodiments, a virtual router may serve a control plane of network function virtualization (NFV) and open platform forwarding entities (OFE) may serve a data plane.

FIG. 2B is a diagram schematically illustrating an architecture of a software stack according to various embodiments of the present invention.

A software stack 14000 may further include a management/setting module performing an operation of managing and/or setting a network service. The management/setting module 14100 may perform operations including a container automatic distribution operation such as Puppet, Ansible, etc., a remote procedure call operation such as gRPC, HTTP API, etc, an openflow operation, a user plane-data plane bridge interface such as 3GPP N4, a command line interface, a simple mail transfer protocol (SMTP), etc.

The software stack 14000 may further include a service module 14200 performing an operation of providing and/or controlling the network service. The service module 14200 may provide a state service, a Multi-Access Edge Computing (MEC)-Data Plane (DP) service, a routing service such as Quagga/FRR, 5G User Plane Function (UPF), a platform service, a link aggregation (LAG) service, etc.

The software stack 14000 may further include an interface module 14300 performing an input/output operation of the network function performed in the smart NIC 20000 or the general NIC 30000 and the edge node CPU. The interface module 14300 may include the data plane management module 13000 or perform all or some operations required for input/output. The service module 14200 may include a switch abstraction interface 21100 performing the input/output with the smart NIC 20000 or the general NIC 30000 by simulating a direct access or call the switch abstraction interface 21100 from the outside and perform the switch abstraction interface 21100. The interface module 14300 may include the compiler 15000 performing all or some operations of generating the binary or call the compiler 15000 from the outside or perform the compiler 15000.

The interface module 14300 may include a compiler-based hardware abstraction layer 13100, and a service operation performed by the service module 14200 may enable the service module to access and control the smart NIC 20000 through the switch abstraction interface 21100 performing the input/output with the smart NIC 20000 or the general NIC 30000 by simulating the direct access as the binary built in the compiler 15000 is executed in hardware of the smart NIC 20000. The interface module may include one or more channels 14310 mapped to a physical port or a virtual port of the smart NIC 20000 or the general NIC 30000 to be manipulated.

The interface module 14300 may be all included in the software stack 14000 or included as an interface capable of calling an external module.

FIG. 2C is a diagram schematically illustrating a port mapping relation between an architecture of a software stack and smart NIC according to various embodiments of the present invention.

The electronic device may further include a memory, and an operating system allocating and/or controlling a resource of the electronic device may be allocated to the memory, and the memory may include an operating system kernel 12000 performing an operation for the operating system to directly control and an operating system user area 15000 performing the operation for a user using the electronic device to control the electronic device.

The operating system kernel 12000 may directly access the resource of the smart NIC 20000 or the general NIC 30000 and directly access the CPU 11000.

The high-speed data path framework 12100 may perform an operation of accessing and/or controlling a port 22000 of the smart NIC 20000 or the general NIC 30000 through the operating system kernel 12000, and generate and/or remove a virtual function port 22300 which does not present physically, but is capable of inputting/outputting the packet in the same manner as an actual physical port.

The operating system user area 15000 may be allocated with some resources of the electronic device from the operating system kernel 12000 and may execute one or more app containers 15100 executing a single virtual operating system or a part of the operating system in the operating system user area 15000 and include the app containers 15100, and the app container 15100 may include a network service app 15120. Further, in the app container 15100, the software stack 14000 may be the software stack container 15200 executed as the software stack 14000. The network service app 15120 may be an application providing an Artificial Intelligence service, a Contents Delivery Network, an augmented reality (AR) service, a virtual reality (VR) service, etc., with respect to a Multi-Access Edge Computing (MEC).

The app container 15100 or the software stack container 15200 may process a packet required for the service through the high-speed data path framework 12100 between Single Root I/O Virtualization (SRIOV) and the virtual function port 22300.

The channel 14310 connected to the software stack 14000 may be mapped to the physical port 22000 or the virtualization function port 22300 in software.

According to various embodiments, a intelligence connected vehicles (ICV) combined with the network, in particular, the cloud may provide a more secure and environmentally friendly traffic system. However, the existing network is limited to providing short delay response time, and may be limited due to unique delay, discontinuation, and non-flexibility in dynamic changes.

According to various embodiments, a smart NIC based networking solution may provide a 5G system architecture based ICV communication platform. The smart NIC based networking solution may solve a forwarding performance problem of the existing CPU based network function. The smart NIC based networking solution may perform network function virtualization (NFV) by introducing a concept of a software defined network (SDN) compiler.

According to various embodiments, the smart NIC based networking solution may perform a service providing system requiring ultra delay switching such as a financial trading system and a large content transmission system such as an AR/VR content transmission system or a streaming game system.

According to various embodiments, the smart NIC based networking solution may offload ICV traffic transmission to hardware through a software defined network method. In addition, the smart NIC based networking solution may provide a system that may guarantee and mutually operate a service level agreement (SLA) of heterogeneous network slices.

According to various embodiments, the hardware offloading may solve the CPU load minimization due to DDoS attacks and stability and security problems of the service caused due to the CPU load minimization. The Smart NIC based networking solution may provide a system that enhances the stability and security of the service by blocking the CPU from networking-based external hacking and attacks in advance by strict separation between networking and CPU-based applications.

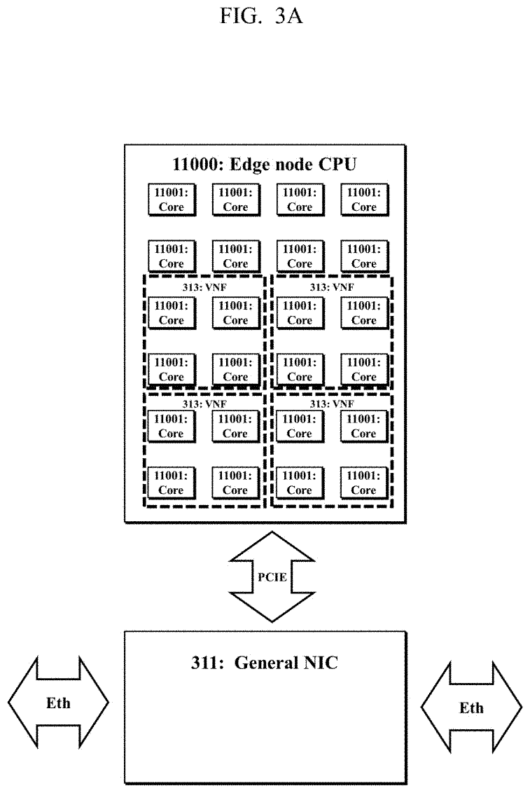

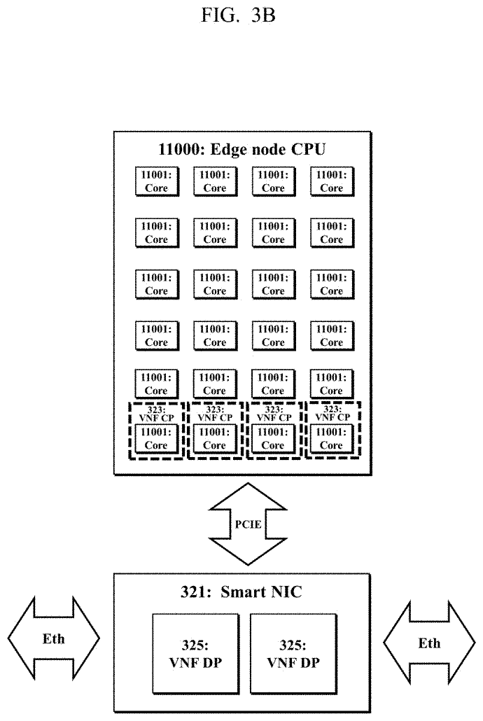

FIGS. 3a and 3b are diagrams illustrating a difference between a smart NIC based networking solution and the other networking solution according to various embodiments of the present invention.

According to various embodiments, referring to FIG. 3A, conventionally, a virtual network function (VNF) 313 may be performed fully by an edge node CP. Thereafter, the PCI express (PCIE) may communicate with a traditional NIC (e.g., hardware based NIC) 311 and transfer data. For example, conventionally, since 16 cores of the edge node CPU are used for performing the virtual network function (VNF), an overload of the edge node CPU may be caused. For example, in the case of conventional Single Root I/O Virtualization (SRIOV), there may be a limit that only 16 virtualization functions may be generated.

According to various embodiments, referring to FIG. 3B, in the case of the smart NIC based networking solution, the virtual network function (VNF) may be divided into a VNF control plane (CP) 323 and a VNF data plane (DP) 325, and the VNF CP may be performed by the edge node CPU and the VNF DP may be performed by the smart NIC (e.g., software based NIC 321). For example, in the case of the smart NIC based network solution, since 4 cores of the edge node CPU are used for performing the virtual network function (VNF), the load of the edge node CPU may be relatively reduced. For example, using the smart NIC, the virtualization function to process the packet in the conventional CPU is compiled and replaced with a compiler in an NIC step. That is, the smart NIC may be defined as a software compiler and offloading of the virtualization function may be performed.

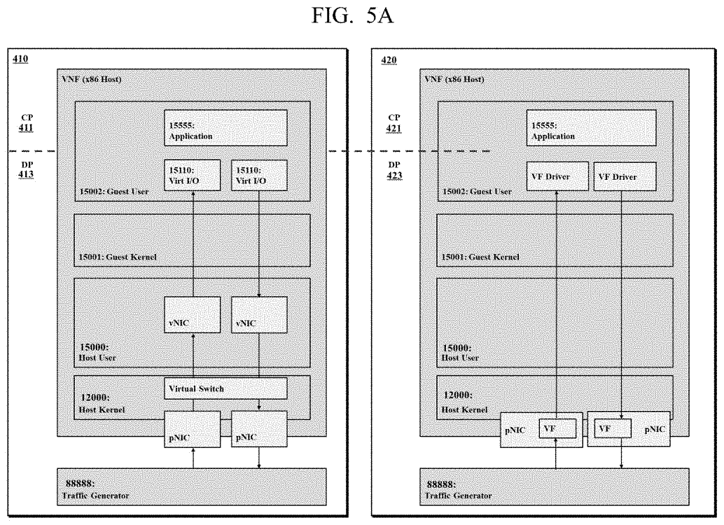

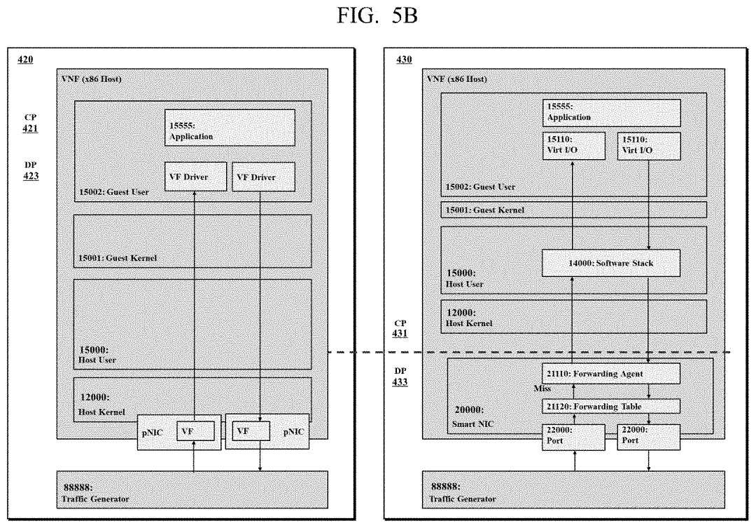

FIGS. 5a and 5b are diagrams illustrating a difference between a smart NIC based networking solution and the other networking solution according to various embodiments of the present invention.

According to various embodiments, a smart NIC based networking solution 430 may have a difference from a software networking-based solution 410 and an SRIOV based networking solution 420 in terms of the architecture. For example, the smart NIC based networking solution 430 may separate a control plane (CP) 431 and a data plane (DP) 433 to perform forwarding. For example, the data plane 433 may be constituted by a hardware level forwarding table and an agent for the control plane 431. For example, the control plane 431 may be constituted by an NFV based user application, the agent, and the compiler application. For example, the smart NIC based networking solution 430 may offload the NFV of the data plane 433 with a hardware switch and guarantee a hardware level quality of service (QoS) in performing a network slice. That is, a virtualization network (e.g., switch, router, etc.) is accelerated to perform very low cost and near-real-time response communication.

According to various embodiments, in the software networking-based solution 410 and the SRIOV based networking solution 420, the control planes 411 and 421 and the data planes 413 and 423 may perform all operations from a guest user to a host kernel. However, in the smart NIC based networking solution 430, the operation from the guest user to the host kernel may be performed by the control plane 431 and thereafter, the virtualization function may be performed by the data plane 433.

According to various embodiments, the smart NIC based networking solution 430 may include a software stack, e.g., a Loxilight software stack as a brand name of NerLOX. The software stack may include all or some of a P4 core compiler, an offload conflict resolver, and a function loader (Function loader).

The P4 core compiler may understand a high level of P4 intermediate representation and may be output as a variety of logic of a format such as Verilog, Micro-Code, eBPF, or Vendor SDK C code.

When P4 language intermediate representation conflicts with hardware of the smart NIC and or a hardware resource of the general NIC, the offload conflict resolver may change an output format of the P4 core compiler with a logic of a format in which the conflict does not occur.

The function loader may compile logic data output from the compiler, e.g., an Extended Berkeley Packet Filter (eBPF) user program into an eBPF byte code and load the Extended Berkeley Packet Filter (eBPF) user program to the data plane. The function loader may load the logic data output from the compiler to an operating system kernel area of the electronic device through XDP, for example, by using a Low Level Virtual Machine (LLVM) and/or Clang compiler for a hardware block of the smart NIC or a hardware block of the general NIC, load the logic data to FPGA of the smart NIC by a proprietary interface, or load a network processor of the smart NIC by the proprietary interface.

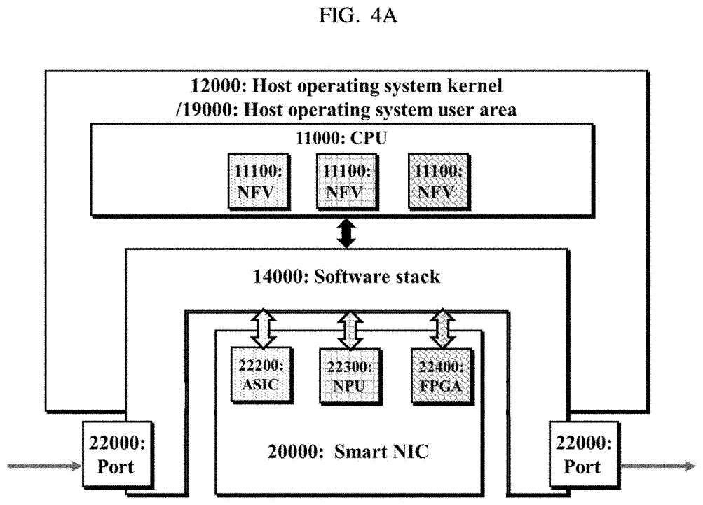

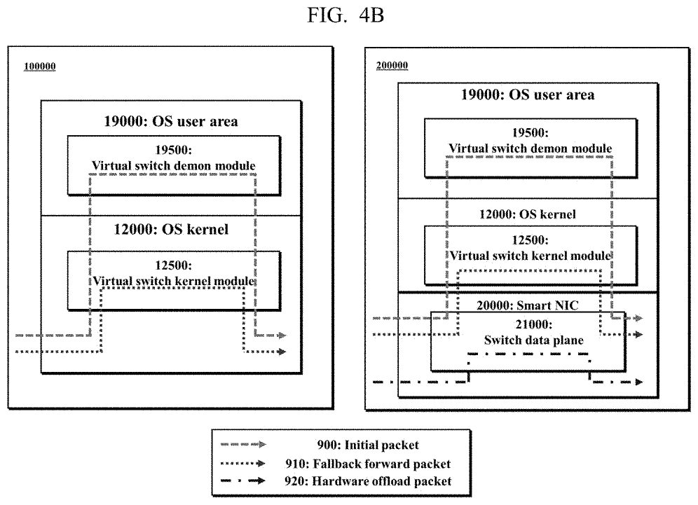

FIG. 4A is a diagram schematically illustrating a packet flow of a smart NIC based networking solution according to various embodiments of the present invention. It can be seen that the NFVs 11100 loaded on the CPU 11000 are offloaded to the ASIC 22200, the NPU (22300), and the FPGA 22400 of the smart NIC 20000, respectively, and the load of the CPU 11000 may be dispersed and various hardware functions of the smart NIC may be utilized.

FIG. 4B is a diagram schematically illustrating a packet flow of a smart NIC based networking solution according to various embodiments of the present invention. In the case of an electronic device 100000 using a conventional virtual switch function, since a delay rate is high and a bandwidth is low, and the load is concentrated in the CPU, the packet processing may be delayed, but in the case of an electronic device 200000 according to an embodiment of the present invention, since the packet is offloaded to the smart NIC, the delay rate is low, the bandwidth becomes high, and the load is dispersed to the CPU, to accelerate the packet processing.

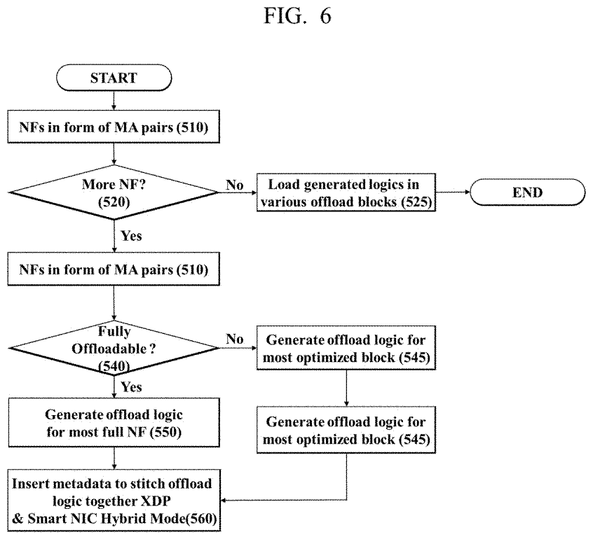

FIG. 6 is a flowchart for an algorithm of a smart NIC based networking solution according to various embodiments of the present invention.

According to various embodiments, in the case of a smart NIC based networking solution 500, network functions of a match-action (MA) pair form may be checked in operation 510.

According to various embodiments, in the case of the smart NIC based networking solution 500, it may be checked whether there are more network functions in operation 520.

According to various embodiments, in the case of the smart NIC based networking solution 500, when more network functions are not preset, operation 520 is branched to operation 525 to load generated logic in the form of various offload blocks.

According to various embodiments, in the case of the smart NIC based networking solution 500, when more network functions are preset, operation 520 is branched to operation 530 to generate baseline fallback for eBPF (BPF virtual machine) and eXpress Data Path (XDP).

According to various embodiments, in the case of the smart NIC based networking solution 500, it may be checked whether full offload is achieved in operation 540.

According to various embodiments, in the case of the smart NIC based networking solution 500, when the full offload is not achieved, operation 540 is branched to operation 545 to generate offload logic for an optimized block and operation 545 is branched to operation 560 to insert metadata for stitch offload logic in an XDP & smart NIC hybrid mode.

According to various embodiments, in the case of the smart NIC based networking solution 500, when the full offload is achieved, operation 540 is branched to operation 550 to generate offload logic for a most full network function and operation 550 is branched to operation 560 to insert the metadata for stitch the offload logic in the XDP & smart NIC hybrid mode.

Table 1 below shows a GTP tunnel management heuristic algorithm of the smart NIC based networking solution according to various embodiments of the present invention.

TABLE 1
Algorithm 1 GTP Tunnel Management Heuristic

Procedure: gtp_tunnel_add( ):
in-args: tunnel_name, tunnel src-ip, tunnel dst-ip, ingress tunnel-id,
egress tunnel-id, vrf-id
out-args: Error Code or 0 for success.
Description: Create a new GTP tunnel interface with a terminating
end-point.
1. Prepare tunnel hash key with ingress tunnel-id, egress tunnel-id, vrf-id.
2. Lookup the Tunnel hash table for existing tunnel element
3. If present then return with error ALREADY_EXIST else continue.
4. Allocate tunnel element and copy tunnel key, tunnel src-ip, tunnel
dst-ip, ingress tunnel-id and egress tunnel-id.
5. Store tunnel element in tunnel hash table.
6. Install incoming GTP tunnel flow with Match dst ip as tunnel src-ip,
src ip as tunnel dst-ip, ingress tunnel-id, gtp udp dst port with
actions DECAP_GTP_TUNNEL.
7. Return 0
Procedure: gtp_tunnel del( ):
in-args: tunnel_name, ingress tunnel-id, egress tunnel-id, vrf-id
out-args: Error Code or 0 for success.
Description: Delete a existing GTP tunnel interface.
1. Prepare tunnel hash key with ingress tunnel-id, egress tunnel-id, vrf-id.
2. Lookup the Tunnel hash table for existing tunnel element.
3. If not present then return with error NOT_EXIST else continue.
4. Uninstall Incoming GTP tunnel flows with match tunnel src-ip,
tunnel dst-ip, ingress tunnel-id, gtp udp dst port.
5. Remove tunnel element from tunnel hash table.
6. Return 0

According to various embodiments, the GTP tunnel management heuristic algorithm may include creating a new GTP tunnel interface by using a terminal point (S100), and the creating of the GTP tunnel interface (S100) may include the following steps:

preparing a tunnel hash key by using an ingress tunnel ID, an egress tunnel ID, and a Virtual Routing and Forwarding (VRF) ID (S110);

looking up a tunnel hash table for an existing tunnel element (S120);

terminating creation of a GTP tunnel interface when the existing tunnel element is present in the tunnel hash table (S130);

allocating a tunnel element and copying a tunnel key, a tunnel source IP, a tunnel destination IP, an ingress tunnel ID, and an egress tunnel ID to the allocated tunnel element (S140);

storing the tunnel element in the tunnel hash table (S150); and

installing an incoming GTP tunnel flow by using the tunnel source IP as a destination IP, a tunnel destination IP as a source IP, the ingress tunnel ID, and a GTP UDP destination port and operation DECAP_GTP_TUNNEL (S160).

According to various embodiments, the GTP tunnel management heuristic algorithm may include removing a GTP tunnel interface by using the terminal point (S200), and the removing of the GTP tunnel interface (S200) may include the following steps:

preparing a tunnel hash key by using an ingress tunnel ID, an egress tunnel ID, and a Virtual Routing and Forwarding (VRF) ID (S210);

looking up a tunnel hash table for existing tunnel element (S220);

terminating removal of a GTP tunnel interface when the existing tunnel element is present in the tunnel hash table (S230);

removing an incoming GTP tunnel flow by using the tunnel source IP as a destination IP, a tunnel destination IP as a source IP, the ingress tunnel ID, and a GTP UDP destination port and operation DECAP_GTP_TUNNEL (S240); and removing the tunnel element from the tunnel hash table (S250).

Table 2 below shows a GTP user flow management heuristic algorithm of the smart NIC based networking solution according to various embodiments of the present invention.

TABLE 2
Algorithm 2 GTP User Flow Management Heuristic

Procedure: gtp_user_flow_add( ):
in-args: src-ip, dst-ip, ip-proto, 14 src port, 14 dst port, in-port,
tunnel-name
out-args: Error Code or 0 for success
Description: Create a new GTP User flow
1. Prepare user flow hash key with src-ip, dst-ip, ip-proto, 14 src port,
14 dst port, in-port.
2. Lookup the user flow hash table for existing user flow element.
3. If present then return with error ALREADY_EXIST else continue.
4. Lookup the tunnel element with tunnel name as auxiliary key.
5. Allocate user flow element and copy user flow key and tunnel elem.
6. Store user flow element in user flow hash table.
7. Install ingress user flow with match tunnel attributes for outer header
and user flow attributes for inner header with actions DECAP_
GTP_TUNNEL.
8. Install egres user flow with match user flow attributes and action as
ENCAP_GTP_TUNNEL with gtp tunnel attributes.
9. Return 0
Procedure: gtp_user_flow_del( ):
in-args: tunnel_name, ingress tunnel-id, egress tunnel-id, vrf-id
out-args: Error Code or 0 for success
Description: Delete a existing GTP User flow
1. Prepare user flow hash key with src-ip, dst-ip, ip-proto, 14 src port,
14 dst port, in-port.
2. Lookup the user flow hash table for existing user flow element.
3. If not present then return with error NOT_EXIST else continue.
4. Uninstall egress user flow with match user flow attributes.
5. Uninstall ingress user flow with match tunnel attributes for outer
header and user flow attributes for inner header.
6. Remove user flow element from user flow hash table.
7. Return 0

According to various embodiments, the GTP tunnel management heuristic algorithm may include creating a new GTP user flow (S300), and the creating of the new GTP user flow (S300) may include the following steps:

preparing a user flow hash key with a source IP, a destination IP, an IP proto, an 14 source port, and 14 destination port, and an in-port (S310);

looking up a user flow hash table for an existing user flow element (S320);

terminating the creation of the new GTP user flow if the existing user flow element is present in the user flow hash table (S330);

looking up a tunnel element by using a tunnel name as an auxiliary key (S340);

allocating a user flow element and copying a user flow key and the tunnel element to the allocated user flow (S350);

storing the user flow element in the user flow hash table (S360);

installing an ingress user flow in which a tunnel attribute of an outer header and a user flow attribute of an inner header match (S370); and

installing an egress user flow with matched user flow attribute and action as ENCAP_GTP_TUNNEL with a GTP tunnel attribute (S380).

According to various embodiments, the GTP tunnel management heuristic algorithm may include removing a GTP user flow (S400), and the removing of the GTP user flow (S400) may include the following steps:

preparing a user flow hash key with a source IP, a destination IP, an IP proto, an 14 source port, and 14 destination port, and an in-port (S410);

looking up a user flow hash table for an existing user flow element (S420);

terminating the removal of the GTP user flow if the existing user flow element is present in the user flow hash table (S430);

removing an egress user flow by using a matched user flow attribute (S440);

removing an ingress user flow in which a tunnel attribute of an outer header and a user flow attribute of an inner header match (S450); and

removing the user flow element from the user flow hash table (S460).

According to various embodiments, the GTP tunnel management heuristic algorithm may include removing a GTP user flow (S400), and the removing of the GTP user flow (S400) may include the following steps:

preparing a user flow hash key with a source IP, a destination IP, an IP protocol, an 14 source port, and 14 destination port, and an in-port (S410);

looking up a user flow hash table for an existing user flow element (S420);

terminating the removal of the GTP user flow if the existing user flow element is present in the user flow hash table (S430);

removing an egress flow element by using a matched user flow attribute (S440);

removing an ingress user flow in which a tunnel attribute of an outer header and a user flow attribute of an inner header match (S450); and

looking up a user flow hash table for an existing user flow element (S460).

Table 3 below shows a packet input/output event handler heuristic algorithm of the smart NIC based networking solution according to various embodiments of the present invention.

TABLE 3
Algorithm 3 Packet I/O event handler Heuristic
Procedure: cp-hls-vif-init( ):
in-args: SmartNIC Control Plane device name
out-args: Error Code or 0 for success
Description: Creating a RAW Socket for poll event and listening to all
the packets sent on the SmartNIC's control plane device (“”
1. Create a RAW socket, sock with ETH_TYPE_HLS family. (All the
packets sent from the SmartNIC will be having a SHIM Header
comprising of the metadata like incoming port, outgoing port, table
missed)
2. Get the SmartNIC control plane device index
ifidx = if_nametoindex(″vf0_0″)
3. Bind sock to ifidx using bind( )
4. Add a poll event to read all the packets on this socket using vif-rx( ).
Procedure: cp-hls-rx( ):
in-args: Packet buffer
out-args: Error Code or 0 for success
Description: cp-hls-rx ( ) will called by a poll event whenever a packet
from SmartNIC is ready to be received by helios application.
1. Read the SHIM hdr (HLS header) from the packet.
2. Derive the front port (incoming port) information from the HLS header.
3. If no present then return with error NOT_EXIST else continue.
4. Derive a flow from packet's original headers.
5. Send the packet and flow information to all the registered applications.
6. Return 0
Procedure: cp-hls-tx ( ):
in-args: Packet buffer
out-args: Error Code or 0 for success
Description: cp-hls-tx ( ) will called by a poll event whenever a packet
is to be sent to SmartNIC is by helios application.
1. Derive the data path port, dp port from front port (outgoing vif).
2. Prepare the SHIM hdr (HLS header) with outport as dp_port.
3. Concatenate the SHIM header and packet into a local buffer, buff.
4. Get the cp_fd for the control plane device (″vf0_0″)
5. Issue write(cp_fd, buff, MAX_BUF_LEN)
6. Return 0

According to various embodiments, a packet input/output event handler heuristic algorithm may include creating a RAW socket for a poll event and receiving all packets transmitted to a control plane device (“vf0_0”) of a smart NIC (S500) and the creating of the RAW socket (S500) may include the following steps:

creating the RAW socket by using ETH_TYPE_HLS family (S510);

receiving an index of the Smart NIC control plane device (S520);

binding a socket to the received index (S530); and

adding a poll event to read all packets to the socket (S540).

According to various embodiments, a packet input/output event handler heuristic algorithm may include creating a RAW socket for a poll event and receiving all packets transmitted to a control plane device (“vf0_0”) of a smart NIC (S500) and the creating of the RAW socket (S500) may include the following steps:

The algorithm may include receiving a packet of a smart NIC called by a poll event when being ready to be received by a Helios application program (S600), and the receiving of the packet of the smart NIC (S600) may include the following steps:

reading an SHIM header (HLS header) from the packet (S610);

deriving front port (incoming port) information from the HLS header (S620);

terminating reception of the packet of the smart NIC if the front port (incoming port) information is not present (S630);

reading a flow in an original header of the packet (S640); and

sending the flow information and all registered application programs (S650).

The algorithm may include sending a packet of a smart NIC called by a poll event when the packet is sent to the smart NIC by a Helios application program (S700), and the transmitting of the packet of the smart NIC (S700) may include the following steps:

deriving a data path port, dp_port from a front port (outgoing vif) (S710);

preparing a SHIM header (HLS header) by using an outport as dp_port (S720);

concatenating the SHIM header and the packet into a local buffer (S730);

acquiring cp_fd from a control plane device (“vf0_0”) (S740); and

a transferring step of writing contents of the concatenated contents of the local buffer to cp_fd by MAX_BUF_LEN (S750).

A method of an electronic device according to various embodiments may include: an operation of serving, by an edge node CPU including at least one core, a control plane for a network function including a virtualization function; and an operation of serving, by a smart network interface card (NIC), a data plane for the network function including the virtualization function to offload at least some operations for the network function including the virtualization function in at least one core.

The edge node CPU may be configured to perform a virtualization function based on a Complex Instruction Set Computer (CISC) architecture, e.g., a Cx86 architecture.

The edge node CPU may be configured to perform the virtualization function based on a Reduced instruction set computer (RISC) architecture, e.g., an ARM architecture.

The edge node CPU may include 24 cores.

The operation of serving the control plane may include an operation of activating 4 cores among the 24 cores.

The operation of offloading at least some operations for the network function including the virtualization function may include an operation of deactivating 12 cores among at least one core.

The smart NIC may be a software-based NIC.

The smart NIC may be an NIC implemented by a software defined network (SDN).

The smart NIC may be configured to operate with a compiler.

The general NIC may be not the software based NIC but a physical network interface card.

The operation of serving the control plane for the network function including the virtualization function may include an operation of using the compiler in a software stack. For example, the compiler may be a Helios P4 core.

The operation of serving the control plane for the network function including the virtualization function and the operation of serving the data plane for the network function including the virtualization function may be configured not to be executed together by the edge node CPU.

1. A method of an electronic device, comprising:
an operation of serving, by an edge node CPU including at least one core, a control plane for a network function including a virtualization function; and
an operation of serving, by a smart network interface card (NIC), a data plane for the network function including the virtualization function to offload at least some operations for the network function including the virtualization function in the at least one core.

2. The method of claim 1, wherein the edge node CPU includes 24 cores.

3. The method of claim 1, wherein the operation of serving the control plane includes an operation of activating at least some cores among the cores of the edge node CPU.

4. The method of claim 3, wherein the operation of offloading at least some operations for the network function including the virtualization function includes an operation of deactivating the at least some cores.

5. The method of claim 1, wherein the smart NIC is a software-based NIC.

6. The method of claim 5, wherein the smart NIC is an NIC implemented by a software defined network (SDN).

7. The method of claim 6, wherein the smart NIC is configured to operate with a compiler.

8. The method of claim 1, wherein the operation of serving the control plane for the network function including the virtualization function includes an operation of using the compiler in a software stack.

9. The method of claim 1, wherein the operation of serving the control plane for the network function including the virtualization function and the operation of serving the data plane for the network function including the virtualization function are configured not to be executed together by the edge node CPU.

10. An electronic device comprising:
a software stack serving, by an edge node CPU including at least one core, a control plane for a network function including a virtualization function;
a smart NIC including a switch data plane serving a data plane for the network function including the virtualization function; and
an edge node CPU offloading at least some operations for the network function including the virtualization function in the at least one core.

11. The electronic device of claim 10, further comprising:
a compiler in which the virtualization function offloaded from the switch data plane to the edge node CPU generates a binary code performed by the switch data plane.

12. The electronic device of claim 10, further comprising:
a data plane management module performing an operation of transmitting the binary code to the switch data plane and requesting executing the binary code.

13. The electronic device of claim 12, further comprising:
the general NIC,
wherein the data plane management module requests the general NIC to perform a network function which is not virtualized.

14. The electronic device of claim 10, further comprising:
a high-speed data path framework performing an operation of offloading the virtualization function from the switch data plane to the edge node CPU.

15. The electronic device of claim 10, wherein the smart NIC further includes a Field Programmable Gate Array (FPGA).
